(19) United States
(12) Patent Application Publication
(10) Pub. No.: US 2008/0094421 A1
(43) Pub. Date: Apr. 24, 2008

(54) Information display apparatus and information displaying method

(75) Inventor: Takahiro Maeda, Saitama-shi (JP)

Correspondence Address: MORRISON & FOERSTER LLP, 425 MARKET STREET, SAN FRANCISCO, CA, 94105-2482, US

(73) Assignee: Access Co., Ltd., Tokyo (JP)

(21) Appl. No.: 11/985,837

(22) Filed: Nov. 16, 2007

Related U.S. Application Data
(63) Continuation-in-part of application No. PCT/JP2006/308547, filed on Apr. 24, 2006.

(30) Foreign Application Priority Data
May 19, 2005 (JP) 2005-146208

(51) Int. Cl. G09G 5/00

(52) U.S. Cl. 345/661

(57) ABSTRACT

Even when the display contents on the display screen are changed, the entire or a part of the display item is displayed, given a higher priority. When a part of image (20) is displayed in a displayable area (14 or 15) that displays a display item on a display screen, a user designates a portion, which he or she desires to keep it displayed, as a prioritized display section (21). When a change of size or the like of the displayable area (14 or 15) is recognized, in response to the change, a part of image (20, 22 or 23) is extracted so that the designated prioritized display section (21) is displayed in the displayable area (14 or 15), and then, it is placed in the displayable area (14 or 15).

This application is a continuation in part of an international patent application No. PCT/JP2006/308547 filed on Apr. 24, 2006, which is claiming priority from Japanese patent application No. 2005-146208 filed on May 19, 2005.

### TECHNICAL FIELD

The present invention relates to an information display apparatus and an information displaying method, for displaying information on a display screen.

### BACKGROUND ART

Currently, a mobile phone is remarkably coming into widespread use, and its capability is becoming diversified; not only merely making a phone call, but also various functions are progressively added, such as a function to take notes, personal information management, web browsing, image recording and reproducing, music downloading and replaying, and television (TV) broadcast receiving and reproducing. With such addition of the functions, many display items (so-called icons indicating menu items, and a result of execution of an application program, and items such as a memo pad) have come to be displayed on a display screen, in particular, on a so-called standby screen.

Japanese unexamined patent publication No. 2002-55750 discloses a technique in which in order not to interfere with an editing work even when a menu and a main image are simultaneously displayed in a small image display unit of a portable type information terminal having a notebook size, the main image is subjected to scaling down when a function list is displayed, according to a displayed volume of the function list.

Japanese unexamined patent publication No. 2002-55752 discloses a technique in which in order to make a menu easy to see even at the time of simultaneously displaying more than one menu in a small-sized image display unit, as well as to improve an operability, if a second function list is displayed according to a coordinate designation by an input device, while a first function list is being displayed, a priority is placed on displaying the second function list over the first function list, in accordance with a change amount of the designated coordinate.

In the meantime, the mobile phone is designed to display any image arbitrarily designated by a user on a display screen thereof, in particular a standby screen. In this kind of display screen, when various display items are arranged on the screen, a background image or images could be hidden. It is preferable if at least a part of an image especially desired by the user is visible, out of the image designated by the user.

However, the size and the number of various display items, which are simultaneously displayed on the display screen, are not necessarily fixed, and there is a possibility that they are dynamically changed as the user uses the mobile phone. Therefore, a space area where such display items do not exist is also subjected to a dynamic change, and there is a low possibility that the partial image desired by the user coincidentally matches the space area.

In addition, there is also a problem that if the number of the display items is increased, the space area is decreased accordingly, and a new display item cannot be displayed additionally.

### SUMMARY OF THE INVENTION

The present invention has been made in view of the background as described above. An object thereof is to provide an information display apparatus and an information display method that are capable of displaying the whole or a part of a display item on the display screen, given a higher priority, even when the contents being displayed are changed on the display screen.

An information display apparatus according to the present invention comprises a display device having the display screen on which information is displayed; a recognition unit for recognizing a change of at least one of a size and a position of a displayable area for displaying therein a display item on the display screen; a designation unit for designating a priority display condition which is used when part of plural display items to be displayed in the displayable area is selectively displayed in the displayable area; a selection unit for selecting part from the plural display items according to the priority display condition, when the change of at least one of the size and the position of the displayable area is recognized and when it is not possible to place the images in the displayable area; and a placement unit for placing the selected part in the displayable area.

In the present invention, when at least one of the size and the position of the displayable area is changed, the recognition unit recognizes the change. On the other hand, the designation unit designates a prioritized display condition which is used when part of plural display items to be displayed in the displayable area is selectively displayed in the displayable area.

The change of the displayable area may occur in response to a usage state; for example, usage in portrait or usage in landscape orientation. However, it is to be noted that the change of the displayable area may occur also according to other factors.

It is to be noted in the specification that the “display item” here indicates integrated information including data, mainly an image or the like, to be displayed on the display screen. Specifically, this integrated information is made up of information items, such as all or part of the image, all or part of text, a menu item, all or part of a Web page, all or part of icon, and a result of execution of an application program.

In the present invention, the designation unit may designate a partial area of the background image that is displayed on the display screen. The decision unit decides the arrangement positions of the display items according to a predetermined rule when plural display items are additionally arranged on the background image. The relocation unit changes the arrangement positions of the display items in such a manner that upon additionally arranging a display item on the background image, if the arrangement position decided by the decision unit overlaps the area designated by the designation unit, the overlapping is avoided. Accordingly, even when the display items are additionally arranged, the partial area designated in the background image is displayed with the higher priority, without covered by the display items.

The present invention is further provided with a detection unit for detecting that the arrangement positions of the display items being displayed on the background image are changed. When the detection unit detects that the arrangement position of one of the display items is changed, the designation unit may determine as the area designated, an area at a position where the display item having been moved was previously located. Accordingly, it is possible to automatically estimate and set a prioritized display section, without a user's operation to explicitly designate the prioritized display section.

The information display apparatus according to another aspect of the present invention for displaying the information on the display screen, comprises an arrangement unit for additionally arranging the display items sequentially in a space area on the display screen, and a resizing unit for changing the size of at least one of the display items to a smaller one including a prioritized display section which is set in advance to said at least one of the display items, among the display items having already been displayed, if there is no space area to place a new display item when the new display item is added. Then, the arrangement unit additionally places the new display item in the space area obtained by the resizing unit.

In the present invention, the arrangement unit additionally arranges the display items sequentially in the space area on the display screen. The resizing unit changes the size of at least one of the display items to a smaller one including a prioritized display section which is set in advance to the at least one of the display items, if there is no space area to place the new display item when the new display item is added. According to this resizing, the space area is increased. The arrangement unit is capable of additionally placing the new display item in the space area obtained by the resizing, without deleting the entire display items already arranged.

In the resizing unit, when the space area is increased by deleting a display item on the display screen and if the increase of the space area allows a change from the prioritized display section of a particular display item to a larger original size, the size of the display item may be changed from the smaller size including the prioritized display section to a larger original size.

If the prioritized display condition includes priority orders predetermined to the plural display items and if there is a shortage of the space for adding the new display item, even after the resizing is carried out by the resizing unit, the display item arrangement unit may delete one or more of the display items already arranged according to the predetermined order of priority.

The information display apparatus according to another aspect, includes an arrangement unit for additionally arranging the display items sequentially in the space area on the display screen, a designation unit for designating all or part of the display item as a prioritized display section, and a deletion unit deleting all or part of at least one remaining display item from a display item, while preserving at least the prioritized display section, if there is no space for arranging the new display item when the new display item is added.

It is further possible that the present invention is directed to an information display method, following a processing procedure of the aforementioned information display apparatus. The information display method may be treated as a program that is executed by a computer (CPU) of the display apparatus.

According to the present invention, even when the display contents are changed on the display screen, all or part of a particular display item of the image can be displayed with a higher priority on the display screen.

In addition, even when there is a change in the display contents, information necessary for the user is neither hidden nor deleted.

Consequently, there is no more inconvenience that necessary information disappears from the display screen. In addition, this eliminates a cumbersome operation to display the disappeared information again.

### BRIEF DESCRIPTION OF THE DRAWINGS

FIG. 1 is a block diagram showing a schematic hardware configuration example of a mobile phone terminal;

FIG. 2 illustrates an operation according to a first embodiment of the present invention;

FIG. 3 illustrates another operation according to the first embodiment of the present invention;

FIGS. 4A and 4B illustrate an aspect of the embodiment of the present invention, for designating a prioritized display section;

FIGS. 5A-5C illustrate another aspect of the embodiment of the present invention, for designating the prioritized display section;

FIGS. 6A and 6B illustrate alternative aspect of the embodiment of the present invention, for designating the prioritized display section;

FIGS. 7A and 7B illustrate further alternative aspect of the embodiment of the present invention, for designating the prioritized display section;

FIGS. 8A and 8B illustrate an aspect of the embodiment of the present invention for holding the priority display condition data regarding a display of a partial image as a display item;

FIGS. 9A and 9B illustrate another aspect of the embodiment of the present invention for holding the display condition data;

FIGS. 10A and 10B include flowcharts showing an operation when a prioritized display section (an priority display condition) according to an embodiment of the present invention is designated before deciding a displayable area;

FIG. 11 is a flowchart showing an operation when the prioritized display section (the priority display condition) according to the first embodiment of the present invention is designated after deciding the displayable area;

FIGS. 12A and 12B illustrate flowcharts in the case where a partial image explained in FIG. 9B is subjected to trimming in advance;

FIGS. 13A and 13B illustrate an operation example according to a second embodiment of the present invention;

FIGS. 14A and 14B illustrates flowcharts showing an operation according to the second embodiment of the present invention;

FIGS. 15A and 15B illustrates a modified example according to the second embodiment of the present invention;

FIGS. 16A and 16B illustrate an operation example according to a third embodiment of the present invention;

FIGS. 17A-17C illustrate display items according to the third embodiment of the present invention;

FIGS. 18A and 18B illustrate another operation example according to the third embodiment of the present invention;

FIG. 19 illustrates an example of data table that manages the display items on the display screen available in the third embodiment of the present invention;

FIGS. 20A and 20B illustrate flowcharts showing a processing example according to the third embodiment of the present invention; and

FIG. 21 is a flowchart showing the updating of frequency of usage, regarding a modification of the present invention.

### DESCRIPTION OF THE REFERENCE SYMBOLS

11: PORTRAIT SCREEN; 12: LANDSCAPE SCREEN; 13a-13e: MENU ITEM; 14: DISPLAYABLE AREA; 20: IMAGE; 21: PRIORITIZED DISPLAY SECTION; 22: PARTIAL IMAGE; 24: IMAGE; 25: PRIORITIZED DISPLAY SECTION; 27: CURSOR; 30: DISPLAY SCREEN; 31: BACKGROUND IMAGE; 32a-32e: MENU ITEM; 34: PRIORITIZED DISPLAY SECTION; 35: DEFAULT POSITION; 40: DISPLAY SCREEN; 41: MENU ITEM; 42: WEATHER INFORMATION; 43: STOCK PRICE NEWS; 44: TELEPHONE SHORTCUT; 45: ICON; 46: CLOCK APPLICATION; 47: IMAGE; 48: MEMO; 49: NOTIFICATION; 53: IMAGE DB; 54; 56: IMAGE ID; 55: ORIGINAL IMAGE DB; 57: DISPLAY CONDITION DB; 58: DISPLAY CONDITION DATA; 59: TRIMMED IMAGE DISPLAY CONDITION DB; 100: MOBILE PHONE TERMINAL; 104: INPUT UNIT; 105: DISPLAY UNIT; 106: COMMUNICATION UNIT; 106a: ANTENNA; 110: STORAGE UNIT; 111: AUDIO PROCESSOR; 111a: MICROPHONE; 111b: SPEAKER; 112: POWER SOURCE; 300: DATA TABLE

### BEST MODE FOR CARRYING OUT THE INVENTION

Hereinafter, a preferred embodiment of the present invention will be described in detail, with reference to the accompanying drawings. A mobile phone terminal will be described as an embodiment of the information display apparatus according to the present invention.

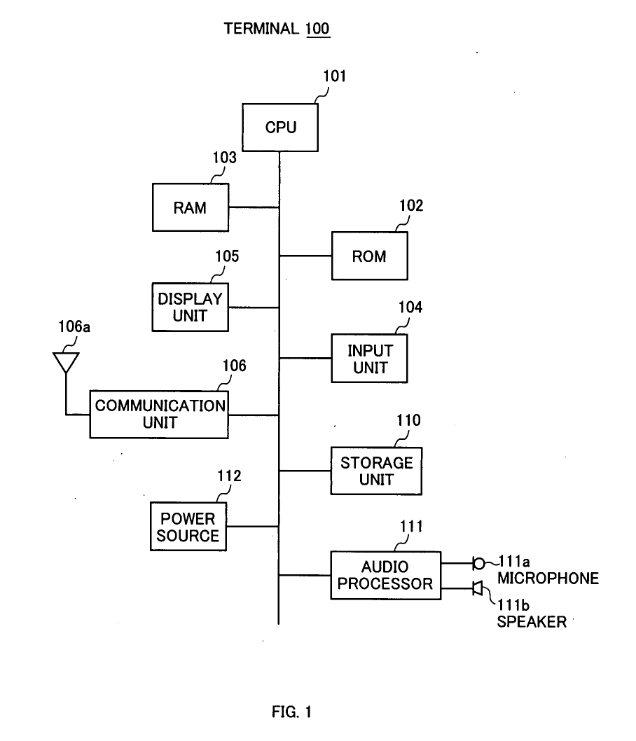

FIG. 1 shows a schematic hardware configuration example of the mobile phone terminal 100.

The terminal 100 comprises a CPU 101, ROM 102, RAM 103, an input unit 104, a display unit 105, a communication unit 106, an antenna 106a, a storage unit 110, an audio processor 111, a microphone 111a, a speaker 111b, and a speaker 112.

The CPU 101 is connected to each of the given parts, and executes a program stored in the ROM 102, thereby configuring a controller for controlling each part of the terminal 100 and implementing various functions (means). The ROM 102 stores programs and fixed data, such as a font, in nonvolatile manner in addition to the program. The RAM 103 is a volatile memory, in general, and utilized by the CPU 101 as a work area and a temporary storage area of data. The storage unit 110 is a nonvolatile storage device that stores in rewritable manner, various data of the terminal, such as address book data, mail data, contents data, image data, and various databases (DB) which will be described below. A storage device, such as a flash ROM, a small-sized hard disk device, etc. may constitute this storage unit.

The input unit 104 is a user interface for a user to input various instructions and data to the terminal 100, and generally includes various keys such as a power key, a telephone key, a numeric keypad, and a cursor operation key. The display unit 105 is a user interface allowing the terminal 100 to provide displayed information to the user, and includes a display device such as a liquid crystal display, an organic Electro-Luminescence display, etc.

The communication unit 106 is a processing part to establish wireless communication with a base station in a mobile phone system via the antenna 106a, allowing phone call and data communication with a communication counterpart via the base station.

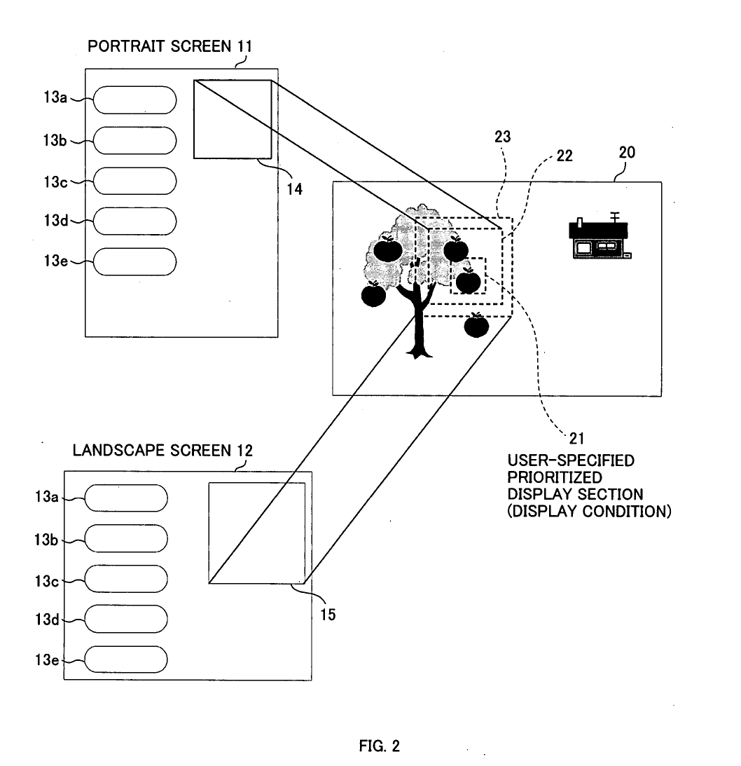

With reference to FIG. 2, an operation according to a first embodiment of the present invention will be described.

In this example, as a factor of variation in size and/or position of the displayable area (e.g. display window) for displaying an image designated by the user, there is assumed a case where the screen is switched between a portrait screen and a landscape screen; in the former the display screen of the terminal being used vertically long, and in the latter the display screen of the terminal being used horizontally long. In other words, as shown in FIG. 2, the arrangement position and the orientation of characters of the menu items such as 13a to 13e are changed between the portrait screen 11 and the landscape screen 12. In accordance with this change, the arrangement position and/or the size of the displayable area are changed as indicated by the areas 14 and 15. The screen as shown in the example is assumed as a standby screen of a mobile phone terminal for instance. When a part of the image 20 being a display item in the present embodiment is displayed in the displayable area, the user operates the input unit 104 (FIG. 1) to designate a prioritized display section to be displayed with a higher priority in the entire display item. In other words, the user arbitrarily designates the image 20 to be displayed in the displayable area, and also designates a part of this image, as the prioritized display section 21. A specific example to designate the prioritized display section 21 will be described below. Here, a rectangular area surrounding a part on which the user focuses attention within the image 20 is designated as the prioritized display section 21. When a part of the image 20 as the display item is displayed in the displayable areas 14 and 15, a part of the display item is extracted, which matches each size of the displayable areas 14 and 15, using the prioritized display section 21 designated as a reference. In other words, when the image 20 is displayed in the displayable area 14 or 15, a partial image 22 or 23 including the prioritized display section 21 designated and having a size corresponding to the size of the displayable area 14 or 15 is extracted, and the extracted image is displayed in the displayable area. Accordingly, even though the size and/or the position of the displayable area are changed, the prioritized display section 21 previously designated by the user always appears in the display window.

The terminal itself is capable of recognizing whether it is used as a portrait screen or as a landscape screen. For example, in the case where the terminal is provided with an attitude sensor (not illustrated), it is possible to automatically change portrait/landscape mode of the display contents based on the output from the sensor. Alternatively, according to a setting or operation by the user, the portrait/landscape mode of the display contents can be changed. There is further an alternative that the terminal itself is allowed to automatically switch the portrait/landscape mode according to a factor such as increase or decrease of the menu items.

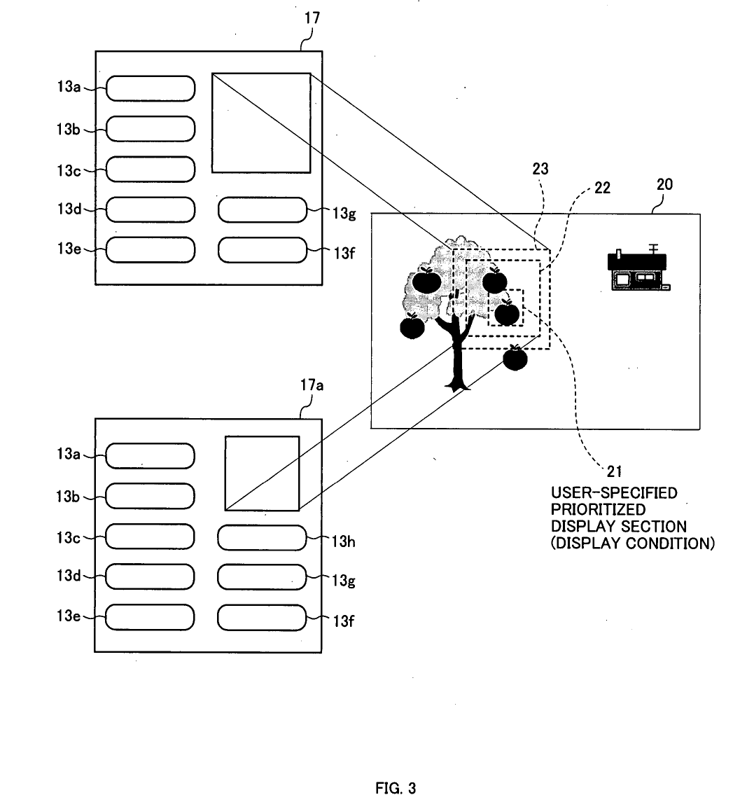

Switching between the portrait screen and the landscape screen is not the only factor of variation in size and/or position of the displayable area. FIG. 3 shows an example that the number of the display items such as 13a to 13g within the screen 17 is changed, as another factor of variation in size and/or position of the displayable area. In the screen 17, a partial image 23 is extracted, which has a size corresponding to the size of the displayable area 15 that is a space where the menu items 13a to 13g do not exist. Then, the partial image 23 is displayed in the displayable area. On the other hand, there is also a case where a menu item 13h is added as shown in the screen surface 17a, according to the operation of the user or a request from the system. In such a case, the size of the space where the display item does not exist becomes smaller, and therefore a partial image 22 is extracted, which has a size corresponding to the size of the new displayable area 14, and the partial image 22 is displayed in the displayable area.

Next, an aspect of the embodiment for designating the prioritized display section will be described. Timing when the prioritized display section is designated by the user is considered as the following; the prioritized display section is designated in advance as an initial setting, before the displayable area is decided, or it is designated after the displayable area is decided.

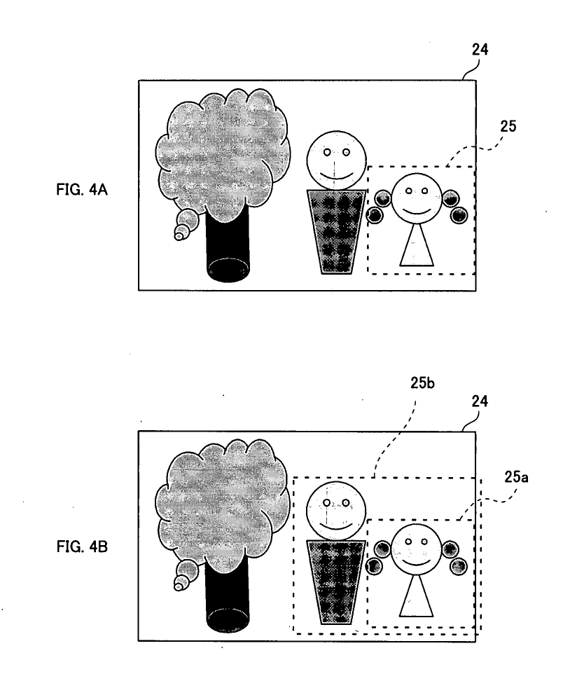

FIG. 4A shows an example where one prioritized display section 25 is designated within the image 24. FIG. 4B shows an example where plural prioritized display sections 25a and 25b having different sizes are designated within the image 24. In this example here, the prioritized display section 25b completely contains the prioritized display section 25a. However, the plural prioritized display sections do not necessarily include a common part. In addition, the plural prioritized display sections may be respectively parts of the original images that are different from one another.

It is possible to switch which prioritized display section is selected, depending on the size (i.e. square measure). For example, if the size of the displayable area is equal to or larger than a predetermined size, a larger prioritized display section 25b is selected. If it is smaller than the predetermined size, a smaller prioritized display section 25a is selected.

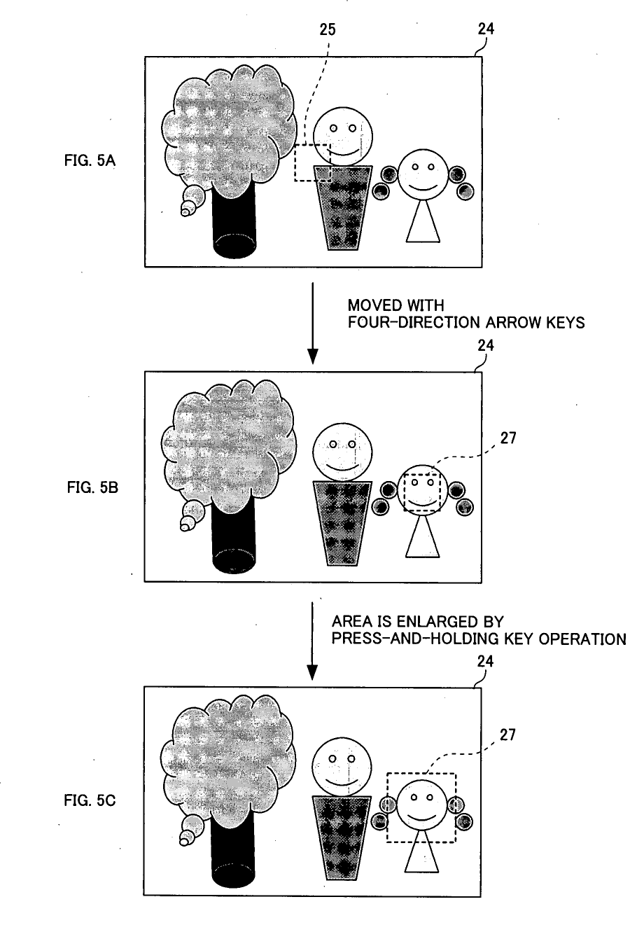

FIGS. 5A-5C show an example for designating the prioritized display section on the image by the user according to an operation of the input unit 104 (FIG. 1). Here, a method will be described, which is suitable for the operation using the input unit of the mobile phone terminal. In this example, in a mode for designating the prioritized display section, an original image of the prioritized display section is displayed on the display unit, and in this state, a cursor 27 having a rectangle shape with a predetermined size is displayed at a predetermined position (a center of the image in the figure) in such a manner as superimposing the cursor on this image (FIG. 5A). Next, the cursor 27 is moved to a desired position according to a predetermined operation of four-direction arrow keys (FIG. 5B). Next, the cursor 27 is enlarged according to a press-and-holding operation of a predetermined key such as a decision key (FIG. 5C). Again, by a predetermined key operation, this prioritized display section is decided. After the press-and-holding operation is performed continuously and the size becomes the maximum, the size may shift to the minimum size, or the current operation may be switched to a scaling-down operation from the maximum size. In this example, the size change is performed after the cursor 27 is moved, however, it may be performed in reverse order, or both operations may be performed in mixed manner.

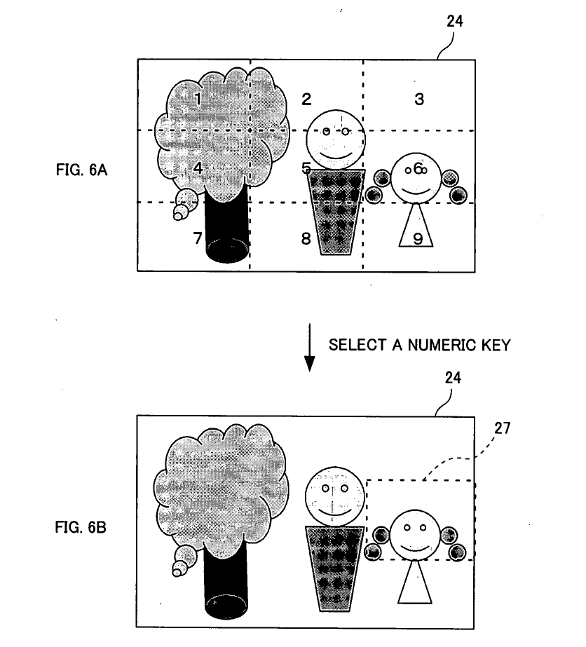

FIGS. 6A and 6B show another aspect of the embodiment for designating the prioritized display section. In this example, when the mode for designating the prioritized display section is started, the image 24 is displayed in such a manner as partitioned equally into a predetermined number of pieces (nine, in this example), and the numbers are displayed in a manner superimposed on respective partitions (FIG. 6A). When the user indicates a desired one of the numbers of the partitions (for example, “6”) by the key operation, the partition is designated as the prioritized display section 25 (FIG. 6B). This example is configured such that the number is assigned to each partition, and the user indicates the number. However, it is alternatively possible that one partition is highlighted at one time, using a highlight display, a rectangular cursor, and the like, and this highlighted partition is moved sequentially to another by the user operation. As a further alternative, the operation explained with reference to FIGS. 5A-5C may be combined with the operation shown in FIGS. 6A and 6B, and they can be executed together.

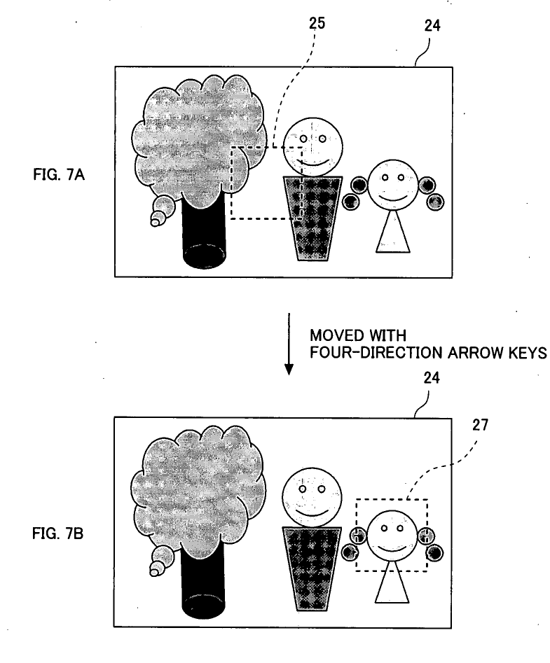

As shown in FIGS. 7A and 7B, in the case where the prioritized display section is designated (or the size is fixed) after the size of the displayable area is decided, the cursor 27 in a rectangular shape, for instance, having the same size as the displayable area is displayed at a predetermined position (FIG. 7A), and this cursor can be moved to a target position according to a predetermined operation such as an operation using the four-direction arrow keys (FIG. 7B), by way of example. The operation as shown in FIGS. 7A and 7B can be combined with the operation as shown in FIGS. 6A and 6B. For example, when one partition is indicated by the operation as shown in FIGS. 6A and 6B, at this position, the cursor 27 suitable for the displayable area size can be displayed automatically. The position of the cursor 27 may further be fine-tuned by the operation using the four-direction arrow keys.

Next, there will be described a priority display condition in the case where the prioritized display section designated by the user is displayed in the given displayable area. The display condition may include the followings:

(1) Prioritized Display Section is Designated Prior to Deciding the Displayable Area

(1-1) Prioritized Display Section is Designated by an Area Such as a Rectangle

a) If the prioritized display section can be contained in the displayable area without any change, it is placed within the displayable area as it is. In this case, the prioritized display section together with its surroundings may be displayed up to the size of the displayable area, or only the prioritized display section may be displayed. There is also a case where the center point of the prioritized display section is made to coincide with the center point of the displayable area; one vertex of one rectangle is made to coincide with one vertex of the other; or the prioritized display section can be positioned anywhere in the displayable area, as far as the prioritized display section is included in the displayable area.

b) If the prioritized display section and the displayable area are different in size, the scale of the prioritized display section may be varied so that it fits into the displayable area (the surrounding part of the prioritized display section is not included), instead of the above procedure a). On this occasion, if the aspect ratio of the prioritized display section is different from that of the displayable area, the aspect ratio of the prioritized display section may be preserved, or not preserved.

c) If there exist plural prioritized display sections, it is automatically determined which prioritized display section is displayed in the displayable area, according to the size, the shape (including the aspect ratio), and other attribute of each prioritized display section. For example, the size is taken as a condition; if the size of a first prioritized display section is smaller than the second prioritized display section, the second prioritized display section is selected when the size of the displayable area is larger than the size of the second prioritized display section, and otherwise, the first prioritized display section is selected. If an element other than the size is used as the priority display condition, the plural prioritized display sections are not necessarily different in size. If the aspect ratio is used as the priority display condition, a prioritized display section having the aspect ratio that is close to the aspect ratio of the displayable area is selected (this is suitable when applied to the case where the scale of the prioritized display section is varied). It can be optionally decided regarding followings: whether or not the aspect ratio of the prioritized display section 21 is preserved, if the aspect ratio of the prioritized display section 21 being selected does not agree with the aspect ratio of the displayable area; whether or not the scale of the prioritized display section 21 is varied if the size is different; whether or not the surrounding part of the prioritized display section 21 is displayed; whether or not the aspect ratio of the displayable area is made to agree with that of the prioritized display section 21, if possible. Here, whether or not the aspect ratio of the displayable area is made to agree with the prioritized display section 21 indicates that the aspect ratio of the displayable area is modified by changing the position and/or the size of other display item, changing between existence and nonexistence thereof, or the like.

d) As an additional priority display condition, it is possible to set a balance, simultaneously with setting of the prioritized display section, when the user sets the prioritized display section for the display item. The “balance” in the present specification represents a ratio of the prioritized display section to the displayable area (frame) (e.g., area ratio). By way of example, it is assumed that in FIG. 2, when the user sets the prioritized display section 21 (apple part), the display balance of the prioritized display section to the displayable area (frame) is specified to be equal to or less than 50%. When the user designates the image 20 for a certain displayable area, if the area ratio of the prioritized display section 21 to the area of the displayable area is equal to or less than 50%, the prioritized display section 21 (a surrounding image including the prioritized display section 21) is displayed as the way it is. However, the displayable area is small and the prioritized display section 21 occupies a large portion of the area of the displayable area (for example, 80%), either of the following will be performed: (i) the prioritized display section 21 and its surrounding part are displayed by scaling down the display item in such a manner that the prioritized display section 21 becomes equal to or less than 50%; and (ii) displaying of this prioritized display section is canceled because the balance condition is not satisfied.

(1-2) Prioritized Display Section is Designated as a Point

a) Setting the designated point as a center, the prioritized display section is displayed including the surroundings in such a manner that the size of the prioritized display section fits into the size of the displayable area. However, if the operation above causes a generation of a blank image within the displayable area, the prioritized display section may be decided so that the center of the image is displaced within the displayable area so as to avoid the generation of the blank image.

(2) Prioritized Display Section is Designated after Deciding the Displayable Area

a) The prioritized display area is determined to fit into the size of the displayable area. On this occasion, the prioritized display section can be designated optionally, by specifying a rectangular area, by specifying a center point of the image, or the like.

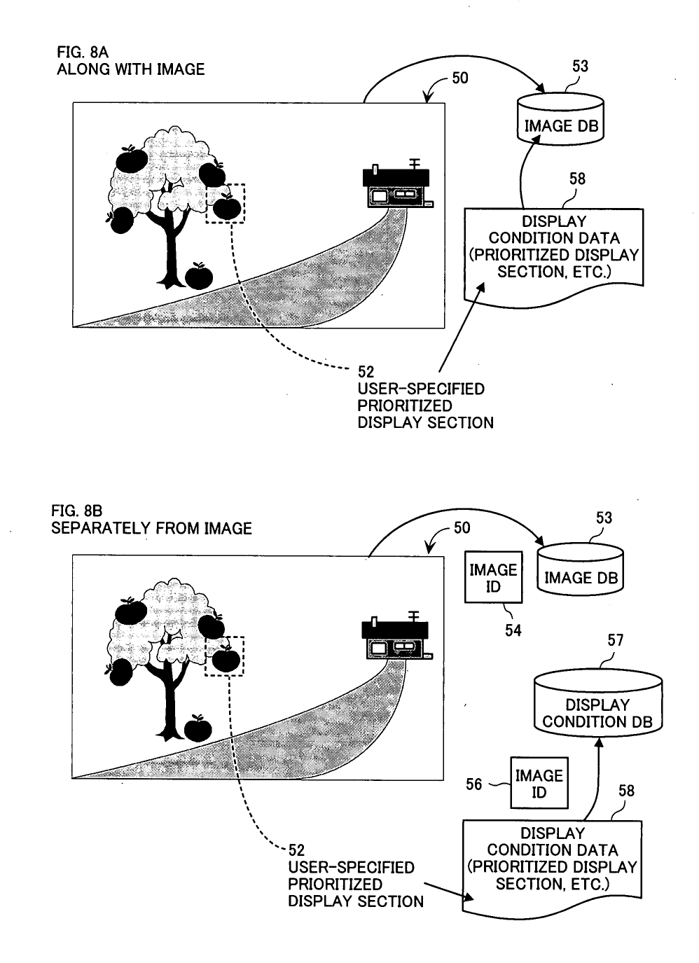

FIGS. 8A and 8B illustrates an aspect of an embodiment for holding a priority display condition data as to displaying a partial image as a display item. FIG. 8A shows an example where a storage unit is provided, and the storage unit stores, along with the image as the display item, positional information representing the prioritized display section that is designated based on the information inputted by the user. In other words, the display condition data 58 is stored in the image database (DB) 53 along with the image data.

FIG. 8B shows an example that there are provided a first storage unit for storing an image as a display item, and a second storage unit for storing positional information representing the prioritized display section designated by the inputted information, separately from the image as the display item, in such a manner as associated with the display item. In other words, the image data is stored in the image DB 53, and the display condition data 58 is stored in the display condition DB 57. The association between the image data and related display condition data is established respectively by the image ID 54 and the image ID 56. The first storage unit and the second storage unit may be different storage areas within an identical storage device (for example, the storage unit 110 in FIG. 1).

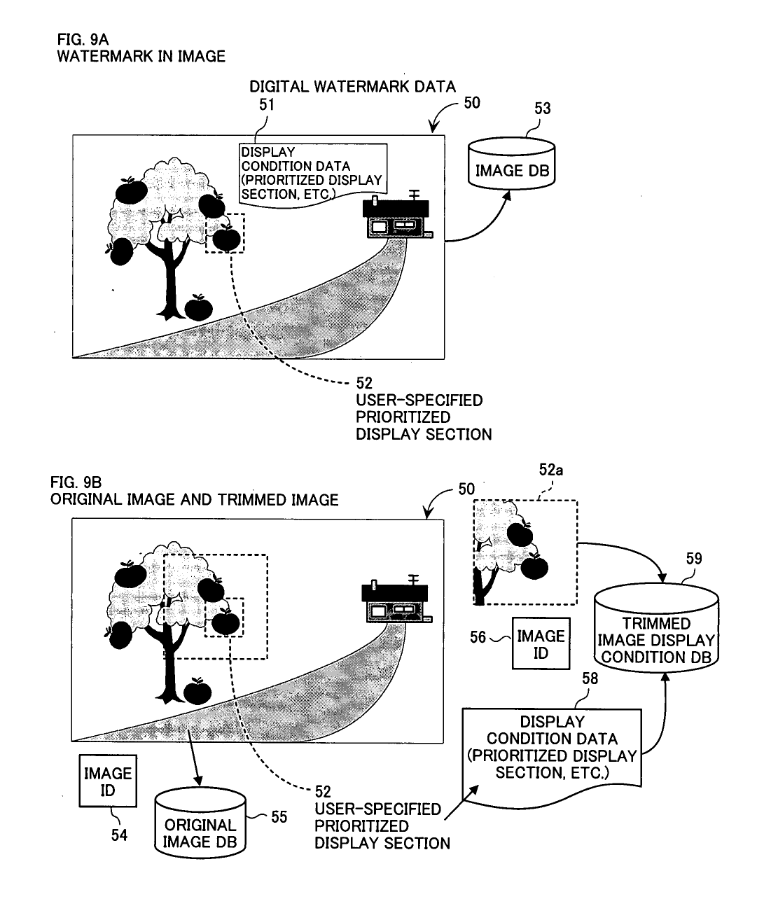

FIGS. 9A and 9B show another aspect of the embodiment for holding the display condition data. FIG. 9A includes an image DB 53 that is a storage unit to store the positional information representing the prioritized display section designated based on the inputted information, this positional information being incorporated as watermark information on the display item. The watermark information is information that is embedded by using the digital watermarking technology. The watermarking technology is originally a security technique that is used for copyright protection for an image, a document, and the like, and information such as a copyright owner and a creation date can be encoded and embedded in a digital copyrighted work, with little influence on the image quality, and the like. In the present embodiment, by using the digital watermarking technology, the display condition data 58 is embedded into the image. Such watermark information can be reproduced by using dedicated software. It is to be noted that such watermarking technology itself is an already-known technology, and a detailed explanation thereof will not be made here.

FIG. 9B illustrates an example as the following: a part of an image as the display item, including the prioritized display section 52, is subjected to trimming in advance to obtain the trimmed image 52a; the trimmed image 52a is made associated with the image 50 as the display item via the image ID 56, and stored in a trimmed image display condition DB 59 as a storage unit; and when the image as the display item is displayed, the trimmed image 52a is readout and displayed. With the procedure above, it is possible to reduce the processing load to expand the original image and subject the partial image to trimming so as to coincide with the size of the displayable area, every time the image is displayed. The display condition data 58 is stored in the trimmed image display condition DB 59 together with the trimmed image 52a. The original image data is stored in the original image DB 55 together with the image ID 54. If the displayable area on the display screen does not coincide with the trimmed image 52a, or the size of the displayable area is changed, trimming is executed again to allow the image fit into the size after the change, and a new trimmed image is generated.

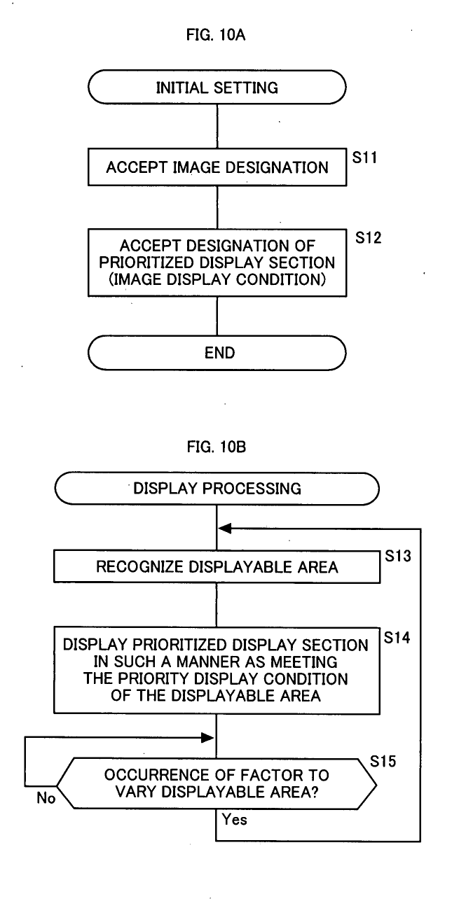

FIGS. 10A and 10B illustrate flowcharts showing an operation when the prioritized display section (and the priority display condition) is designated before deciding the displayable area according to the first embodiment.

As an initial setting shown in FIG. 10A, a designation from a user is accepted, which designates an image as a display item to be displayed in the displayable area (S11), and according to any of the methods described above, a designation of the prioritized display section within the image is accepted (S12). Those information items above are stored as display condition data in the storage unit.

In the subsequent process for displaying the display screen, the displayable area is recognized (S13), and the prioritized display section is extracted and displayed, in such a manner as meeting the above priority display condition being stored (S14). When plural images are specified as the display item, an automatic selection is carried out in accordance with the priority display condition. Thereafter, if any factor for varying the displayable area occurs (S15, Yes), control returns to S13 to recognize a new displayable area, and then the processing above is repeated.

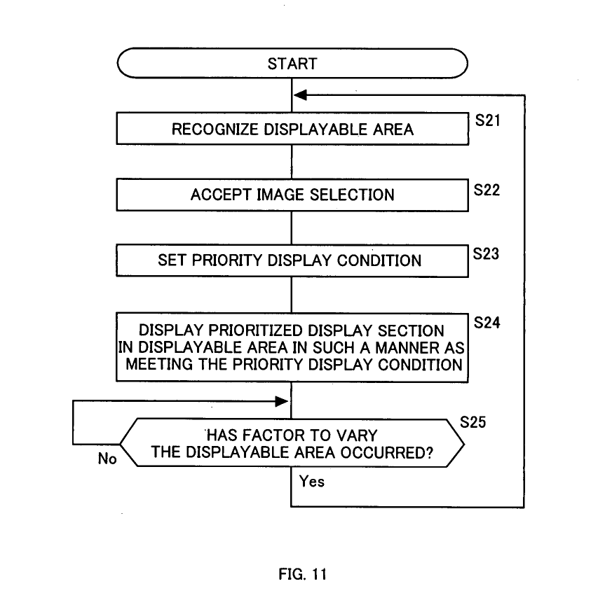

FIG. 11 is a flowchart showing an operation when the prioritized display section (the priority display condition) is designated after deciding the displayable area according to the first embodiment.

Firstly, the displayable area is recognized (S21). Next, a user's selection of an image to be displayed on the displayable area for the user is accepted (S22). Furthermore, a designation by the user of the prioritized display section and other priority display conditions for the image are accepted and the settings thereof are made (S23). Then, the prioritized display section is displayed in the displayable area in such a manner as meeting the priority display condition (S24). Thereafter, if any factor to vary the displayable area occurs (S25, Yes), control returns to S21 to recognize a new displayable area, and then the processing above is repeated.

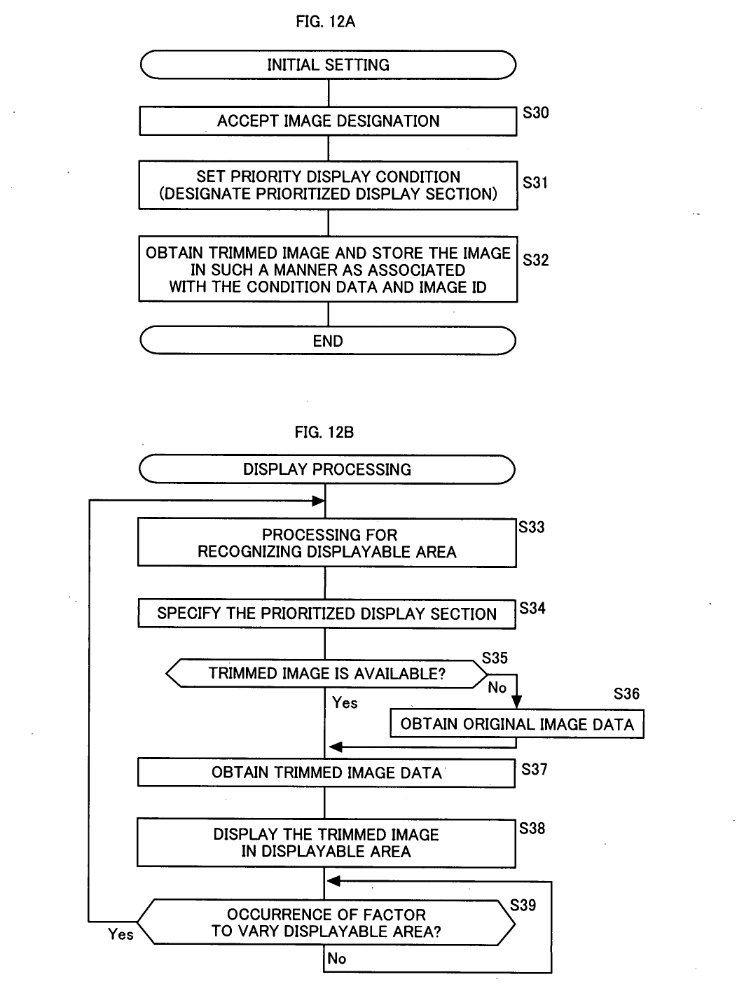

FIGS. 12A and 12B illustrate flowcharts of processing in the case where a part of the image is trimmed in advance as explained with reference to FIG. 9B. In the initial setting as shown in FIG. 12A, firstly, a designation of an image as the display item is accepted (S30), and further, the setting of the priority display condition including the designation of the prioritized display section is configured (S31). Subsequently, the prioritized display section is trimmed, and the trimmed image is stored in the storage unit in such a manner as associated with the condition data of the priority display condition and with the image ID (S32).

In the display processing as shown in FIG. 12B, the displayable area is recognized (S33), and the prioritized display section is specified (S34). Next, it is checked whether or not the trimmed image is available (S35). If it is available, this trimmed image is acquired (S37). If it is not available, an original image is acquired (S36), and then, the trimmed image is acquired again (S37). The trimmed image becomes unavailable when the trimmed image does not fit into the size of the displayable area, or the displayable area is changed. After the trimmed image is acquired, this trimmed image is displayed in the displayable area (S38). Thereafter, if a factor for changing the displayable area occurs (S39, Yes), control returns to S33, and the processing above is repeated.

Next, the second embodiment of the present invention will be described. The configuration of the terminal is the same as in the first embodiment, and therefore tedious explanation will not be made here. The first embodiment shows an example that when a part of the image is displayed in a space area on the display screen, a desired partial image is designated as the prioritized display section. In the second embodiment, in the case where various display items are sequentially added on a background image displayed on the display screen, a part of the background image is displayed with a higher priority. This is to respond to a user's request that at least a part of the background image is demanded to be visible constantly without being covered by the display items being added (for example, menu items).

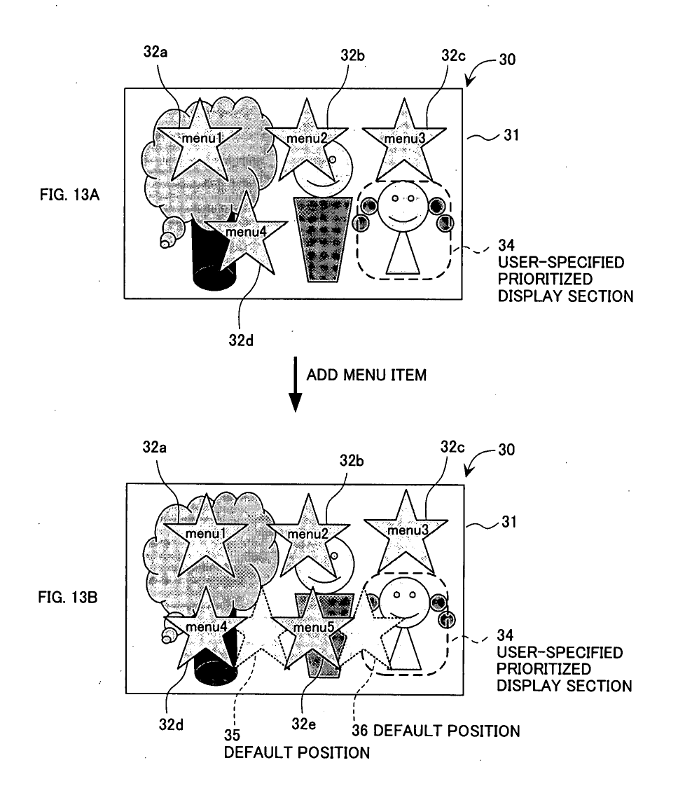

With reference to FIGS. 13A and 13B, an operation example according to the second embodiment of the present invention will be described. As shown in FIG. 13A, plural menu items 32a to 32d are displayed on the background image 31 that is displayed on the display screen 30. These menu items may be sequentially added according to a user's operation or a system request. Here it is assumed that each position for additionally placing these menu items is determined beforehand as a default position. For example, in FIG. 13A, there are four menu items on the background image 31, and when a new menu item 32e is added thereto, original arrangement of the menu items 32d and 32e are the default positions 35 and 36 as shown in the figure. However, if the user designates a part of the background image as the prioritized display section 34, it if found that the menu item 32e overlaps the prioritized display section 34, if the menu item 32e is added on the original position. Given this situation, the arrangement of the menu item 32e is displaced so that it does not overlap the prioritized display section 34. Consequently, if this displacement exerts influence on the menu item already arranged (here, menu item 32d), it is also displaced together therewith. It is to be noted here the prioritized display section 34 can be designated according to the same method as described above.

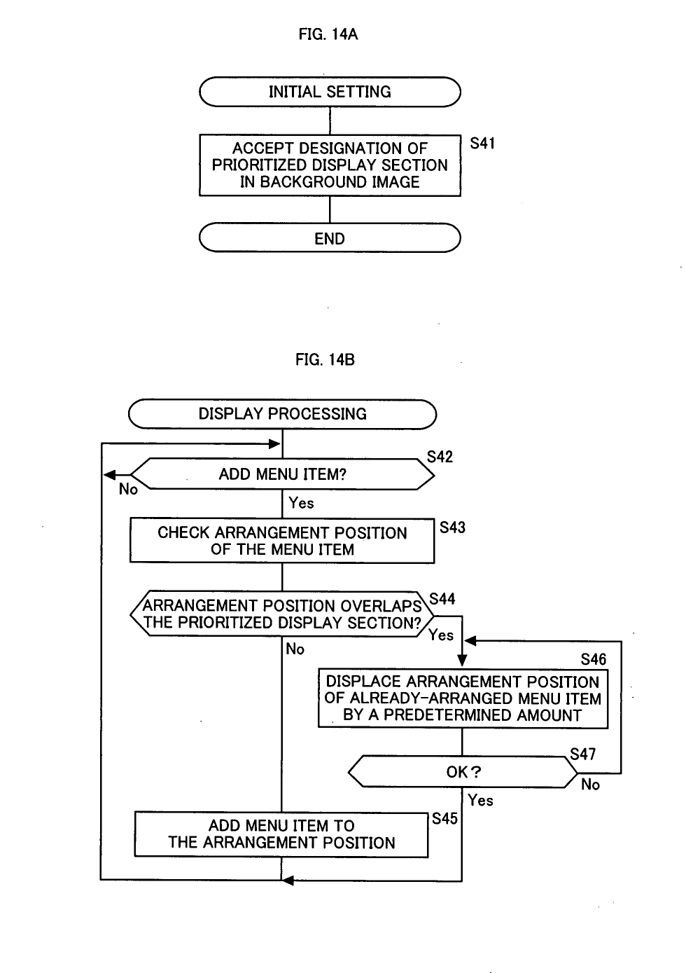

FIGS. 14A and 14B illustrate flowcharts showing an operation according to the present embodiment. FIG. 14A shows an initial setting in which a designation by the user is accepted to designate the prioritized display section 34 within the background, and this designation is registered (S41). Thereafter, in the processing in FIG. 14B, when an addition of a new menu item occurs (S42, Yes), it is checked where is the arrangement position of the new menu item, which is set as a default (S43). It is also checked whether the arrangement position overlaps the prioritized display section (S44). If there is no overlapping, the new menu item is additionally positioned on the arrangement position (S45). If there is an overlapping, the arrangement position of the already arranged menu item is displaced by a predetermined amount in a predetermined direction (S46). This predetermined direction and the predetermined amount can be determined in advance according to the position of the menu item. If any other new problem does not occur such as overlapping between the menu items, due to the change of the position (S47, Yes), control returns to S42 and waits for a new menu item. If a new problem occurs, control returns to S46 and a different menu item is moved even further.

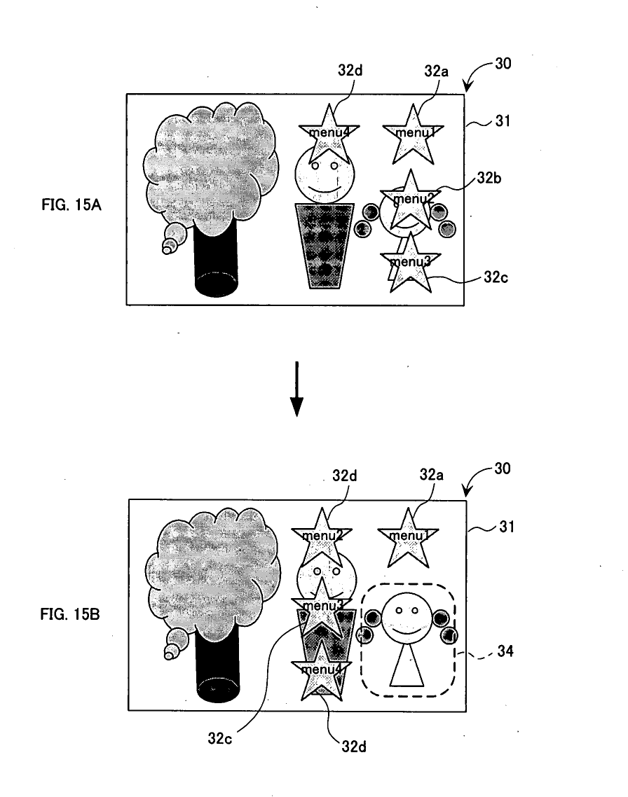

With reference to FIGS. 15A and 15B, a modified example of the second embodiment will be described. In the example shown in FIGS. 13A and 13B, it is assumed that the prioritized display section 34 is explicitly designated by the user. However, it is further possible that the terminal automatically judges and decides the prioritized display section based on a predetermined operation by the user, other than the user operation that explicitly designates the prioritized display section. For example, a case is assumed that when the menu items 32a to 32d are displayed as shown in FIG. 15A, the user moves at least one menu item as shown in FIG. 15B. According to this movement, if there is generated a part of the background image (blank area without any menu items), whose size is larger than a predetermined size, this part is set as the prioritized display section 34. If a new menu item is additionally placed thereafter, it is possible to avoid placing the menu item in this prioritized display section 34. However, if there is no more blank area other than this prioritized display area, the placement on this area may be allowed. This placement may be executed on the condition that the user is inquired about the movement and his or her permission is received.

Next, the third embodiment of the present invention will be described. The configuration of the termSFs54inal is the same as the first embodiment, and therefore tedious explanation will not be made.

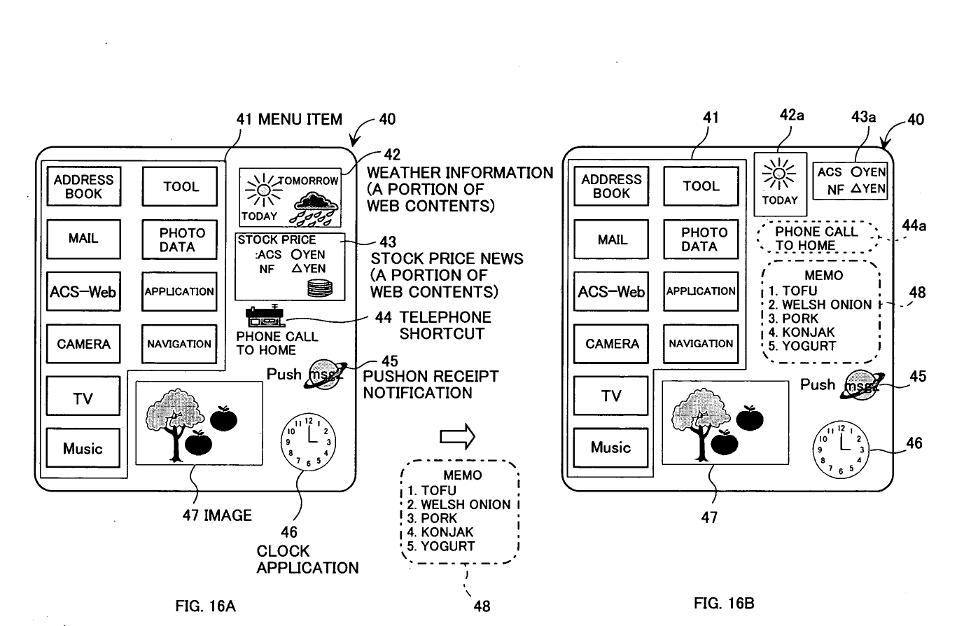

As shown in FIGS. 16A and 16B, various display items are arranged on the display screen 40 of the mobile phone terminal. In this example, in addition to the various menu items 41 to be selected by the user, there are arranged weather information 42 and stock price news 43 as portions of Web contents, a telephone short-cut 44 for calling (for making a call request) to a specific counterpart or place (in this example here, one's home), an icon 45 relating to usage of a specific service, a result of executing a clock application 46, and an image 47 designated by the user. It is to be noted here that the weather information 42 and the stock price news 43 themselves are made up portions of a Web page, and they may be included in the same Web page, or respectively portions of different Web pages. As seen from the figure, the display screen 40 in this state does not have a space for arranging a new display item. As thus described, on the mobile phone terminal having a relatively narrow display screen, if the number of display items arranged on the display screen is increased, additional display of a new display item may become impossible. Therefore, if a new display item, a memo 48 created by the user in this example here, is tried to be additionally arranged on the display screen, there has been no choice but to delete an already-displayed display item from the display screen.

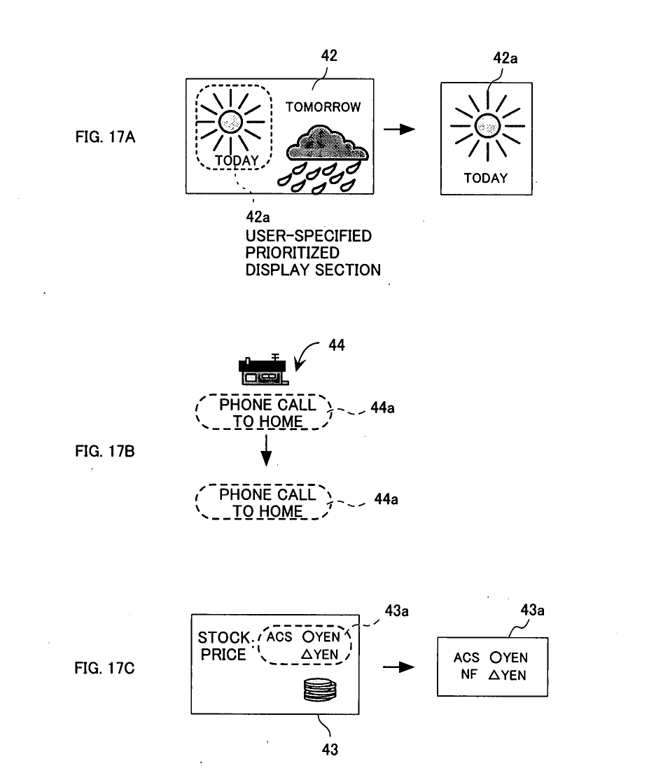

As shown in FIGS. 17A-17C, in the present embodiment, a prioritized display section with a size smaller than the original size is previously decided, as to at least some of the display items. In principle, when the display item is displayed, it is assumed that the size used in this displaying is the original large size. When a new display item is added and there is no space, and if such display item having the prioritized display item as described above is being displayed, the display is switched to the smaller sized display including the prioritized display section. If the space is not sufficient even after changing the display of one display item into a smaller size, another display item is further subjected to the similar changing of display. In the present embodiment, the prioritized display section is a part of the original display item, and it can be designated by the user.

It is to be noted here that if the space area is increased by deleting an image on the display screen, and this increase of the space area allows the prioritized display section of a particular image to change to the original size thereof, this change from the prioritized display section of the particular image to the original size thereof may be automatically performed.

If there is still shortage of space area for adding a new display item, even after performing the display changing to the prioritized display section being available as to all the display items, the already-arranged image is deleted according to a predetermined order of priority.

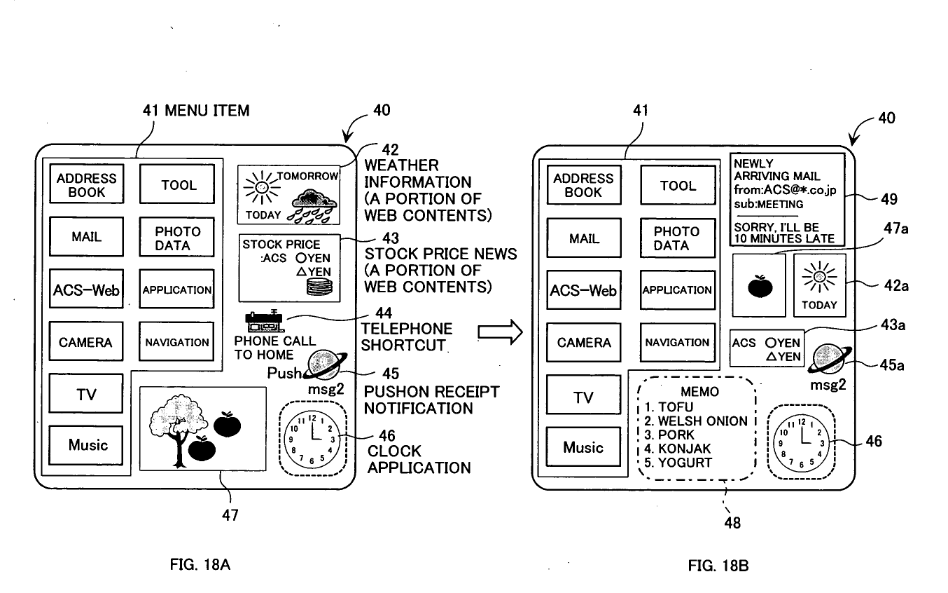

The example as shown in FIGS. 18A and 18B illustrate a situation that the memo 48 is added to the screen 40 of FIG. 18A, and further a newly arriving e-mail notice 49 is displayed, as shown in the screen 40 of FIG. 18B. The weather information 42, the stock price news 43, the icon 45, and the image 47 are set to be the prioritized display sections. The telephone short-cut 44 is deleted from the display screen. A determination which display item becomes a target for deletion is made by the order of priority given to each display item. The order of priority may be predetermined according to a type of the display item, or the user may specify the order. In this example, three stages, high, medium, and low are assumed as the order of priority, and firstly the display item having “low” priority is deleted. After all the display items having “low” priority have been deleted, the display item having “medium” priority becomes the target for deletion next. In addition, since the display item is deleted after it has changed into a prioritized display section having a small size, the order of priority may be given to each prioritized display section, instead of the display item.

As to a particular item, the user is allowed to specify a position where it is fixed. The example of the figure shows that the clock application 46 is designated as a fixed area. After this designation, the position of the clock application 46 does not change. Fixing the position of the display item is not necessarily related to the order of priority for deciding whether the display item becomes a deletion target. Further, it is possible for the user to limit a display item that can be set as a target whose position is fixed.

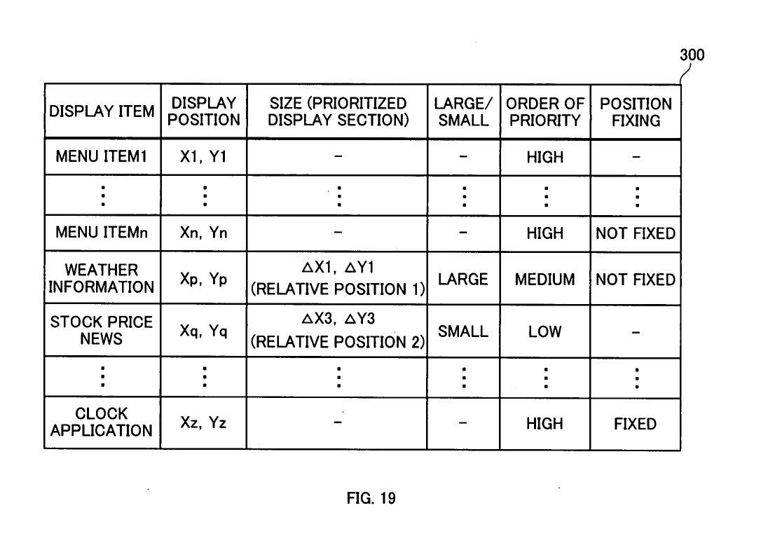

FIG. 19 shows an example of data table 300 that manages such display items on the display screen as described above. This data table 300 specifies for each display item name (or ID) displayed on the display screen, a current display position (X, Y) on the display screen, a size (prioritized display section), large/small (whether the current size is large or small), the order of priority (high, medium, low), and whether or not the position is fixed. In the column “size”, each size (delta X, delta Y) of the display item prepared in advance is recorded when each record is created. As for the display item having the “prioritized display section”, a relative position within the area of the display item is specified in the column “size” together with the size. The “prioritized display section” may be prepared in advance with respect to each display item, or the user may be allowed to designate the section afterwards. Each record of the display item in the data table 300 is created when a display item is added on the display screen, and deleted when the display item is deleted. As for the display item that is allowed to change, a display position, or whether or not the position is fixed can be changed according to a user's operation. This example here shows that the position of the menu item cannot be changed. However, it is possible to allow all the display items to be changed. “Large/small” is updated when the size is changed by the controller. The “order of priority” is previously decided according to the type of display item. However, this order may be specified by the user depending on the display item. This example here shows two stages large/small as for the size, but it is not limited thereto, and three or more stages may be applicable. In addition, as for the order of priority, this example shows three stages. However, it may be two stage, or four stage or more.

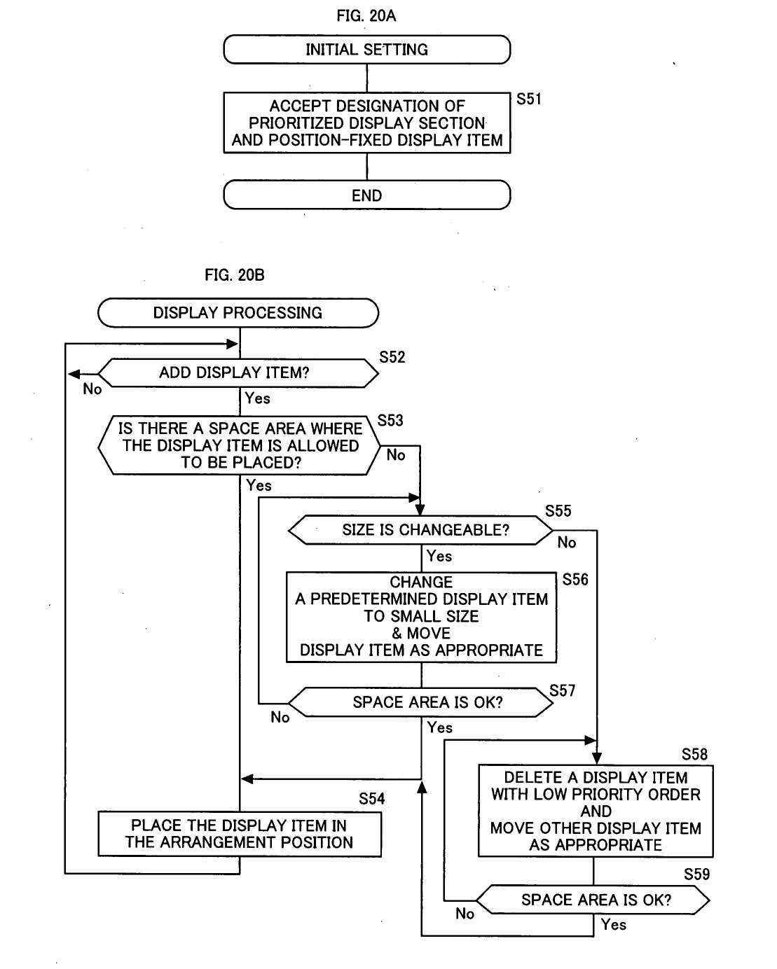

FIGS. 20A and 20B illustrate flowcharts showing a processing example of the third embodiment.

In the initial setting as shown in FIG. 20A, a designation is accepted from the user, which designates the prioritized display section, position-fixed display item, or the like, and it is registered (S51). In the subsequent display processing shown in FIG. 20B, it is firstly determined whether or not there occurs an addition of display item on the display screen (S52). If it is determined that a new display item is added, it is checked whether or not there is a space area where the display item can be placed (S53). If there is such a space area, the display item is placed in that area (S54).

If there is no space area, it is checked whether there is a display item whose size is changeable into the prioritized display section size on the display screen, from the size “Large” (S55). In the case where such display items exist if any, one of such display items is changed into the prioritized display section, and the display item is moved as appropriate, to generate a larger space area (S56). If this space area is available for arranging a new display item (S57, Yes), control shifts to step S54, and the display item is placed therein. If there are plural display items which are changeable into the prioritized display section, the “order of priority” may be considered for deciding which display item is changed to the prioritized display section, or the order of registration, or the like may be considered alternatively.

If the space area is not sufficient in step S57, control returns to S55, and it is checked whether or not there further exists a display item that is changeable to the prioritized display section. If it exists, control shifts to S56, and the processing above is repeated.

If there is no display item changeable to the prioritized display section, or such items do not remain any more, a display item having a low priority is selected and it is deleted from the display screen. Then, other display items are moved as appropriate and much larger space area is generated (S58). If it is configured such that the user is prompted for confirmation or permission on this occasion, this may avoid a case where the display item is deleted without being noticed by the user. If the space area is sufficient for the new display item (S59, Yes), control shifts to S54, and the display item is placed in this arrangement position. If it is determined in step S59 that the space area is not sufficient, control returns to S58, and another display item is deleted from the display screen.

Though not illustrated, when the space area is increased by deleting the display item on the display screen in a situation different from the above step S58, and this increase of the space area allows a particular display item to change from the prioritized display section size to the original larger size, it is possible that this particular display item is automatically resumed to the original larger size from the prioritized display section size. As shown in FIGS. 17A-17C, an example has been described in which the size is switched from large to small if necessary, as a small sized display item that is obtained by setting a part of the large sized display as the prioritized display section. However, as described in the first embodiment, the display item having the small size as the prioritized display section may include the surrounding part thereof when it is switched to the small size, according to the displayable area being provided. Though such procedure is not highly needed in the examples as shown in FIG. 17A, FIG. 17B, and FIG. 17C, it seems usable for the display item like the image 47 as shown in FIG. 16A.

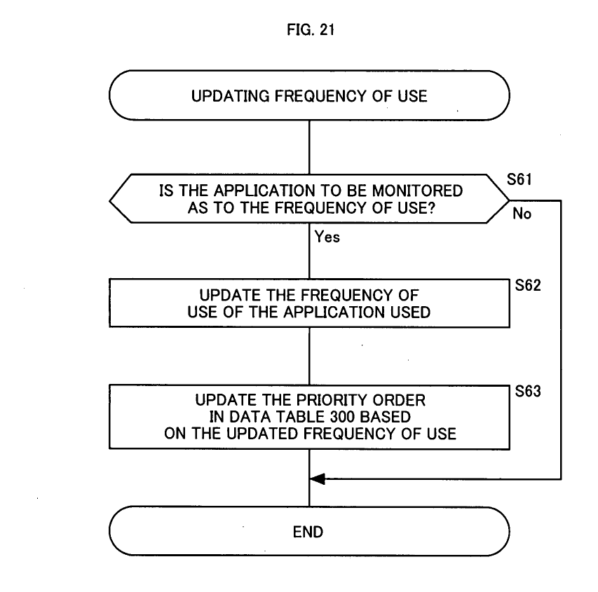

FIG. 21 illustrates a flowchart showing a processing example of updating the frequency of use of an application. This is a process which dynamically change the “priority” of each display item in data table 300 of FIG. 19, based on how frequently the application related to each display item has been used. This process is activated each time the application is used. In this process, a check is made first whether or not the application used is an application to be monitored (S61). Applications, such as the clock application, that run all the time need not be monitored. If the application used is not to be monitored, this process is terminated. If it is to be monitored, the frequency of use of the application used is updated (S62). Based on this updated frequency of use, the “priority” of the display item in the data table 300 is renewed. With this processing, the “priority” dynamically changes due to the user's usage of the application. Typically, the more frequently the application used, the higher the priority of the display item becomes.

Preferred embodiments of the present invention have been explained so far. However, in addition to those descriptions above, various modifications and changes are applicable. By way of example, a standby screen of a mobile phone terminal is assumed as the display screen here, but any display screen is applicable. In addition, the mobile phone terminal has been explained as an example of the information display apparatus, but it is not limited thereto. The present invention is applicable to any information display apparatus having a display screen, such as a mobile information terminal, a mail terminal, a vehicle navigation system, and a game system. In addition, the present invention is preferable when applied to the information display apparatus having a relatively small sized display screen, but this does not exclude an application to an information display apparatus having a large sized display screen. An image treated here is not limited to a still mage only, but also includes a moving image.

What is claimed is:

1. An information display apparatus for displaying information on a display screen, comprising:
a display device having the display screen on which information is displayed;
a recognition unit for recognizing a change of at least one of a size and a position of a displayable area for displaying therein a display item on the display screen;
a designation unit for designating a priority display condition which is used when part of plural display items to be displayed in the displayable area is selectively displayed in the displayable area;
a selection unit for selecting part from the plural display items according to the priority display condition, when the change of at least one of the size and the position of the displayable area is recognized and when it is not possible to place the images in the displayable area; and
a placement unit for placing the selected part in the displayable area.

2. The information display apparatus according to claim 1, wherein said designation unit designates, in response to a user's instruction, a prioritized display section of one of the display items to be preferentially displayed when displaying a part of the display item, and wherein said selection unit extracts, when selecting part of said one of the display items, the part of the display item designated by said designation unit such that the designated prioritized display section is preferentially displayed in the displayable area.

3. The information display apparatus according to claim 1, wherein the display screen is of substantially a rectangular shape and wherein said recognition unit recognizes the change of at least one of the size and the position of the displayable area that varies depending upon a state of usage in portrait or landscape.

4. The information display apparatus according to claim 1, wherein said recognition unit recognizes the change of at least one of the size and the position of the displayable area that varies depending upon decrease/increase of a number of display items on the display screen.

5. The information display apparatus according to claim 1, wherein said extraction unit extracts the designated part of the display item together with a surrounding area depending upon the size of the displayable area.

6. The information display apparatus according to claim 1, wherein said display item includes at least one of icon, menu item, image, and a result of execution of an application program.

7. The information display apparatus according to claim 1, further comprising a storage unit for storing the designated prioritized display section in association with the display item.

8. The information display apparatus according to claim 1, wherein said display item is an image and further comprising a storage unit for storing positional information representing the prioritized display section as watermark information to the image.

9. The information display apparatus according to claim 1, comprising a first storage unit for storing the display items and a second storage unit for storing the designated prioritized display section separately from and in association with the display item corresponding to the designated prioritized display section.

10. The information display apparatus according to claim 7, wherein said storage unit stores a trimmed display item as the prioritized display section in association with the display item, said trimmed display item being provided beforehand by trimming a part of the display item to meet a known size of the displayable area, and wherein said placement unit reads out, when displaying said display item in the displayable area, the trimmed display item and display the same therein.

11. The information display apparatus according to claim 10, wherein when the size of the displayable area changes, a new trimmed item is created by performing a trimming again based on a changed size of the displayable area.

12. The information display apparatus according to claim 1, wherein said designation unit further designates a partial area of the background image that is displayed on the display screen; and further comprising:
a decision unit for deciding arrangement positions of the display items according to a predetermined rule when plural display items are additionally arranged on the background image;
a relocation unit for changing the arrangement positions of the display items in such a manner that upon additionally placing a display item on the background image, if the arrangement position decided by the decision unit overlaps the area designated by said designation unit, the overlapping is avoided.

13. The information display apparatus according to claim 12, further comprising a detection unit for detecting that the arrangement positions of the display items being displayed on the background image are changed; and
said designation unit for determining as the area designated, upon detecting that the arrangement position of one of the display items is changed, an area at a position where the display item having been moved was previously located.

14. The information display apparatus according to claim 1, further comprising:
an arrangement unit for additionally arranging the display items sequentially in the space area on the display screen;
a resizing unit for changing the size of at least one of the display items to a smaller one including a prioritized display section which is set in advance to said at least one of the display items, among the display items having already been displayed, if there is no space area to place a new display item when the new display item is added, whereby the arrangement unit additionally places the new display item in the space area obtained by the resizing.

15. The information display apparatus according to claim 14, wherein the resizing unit changes, when the space area is increased by deleting a display item on the display screen and if the increase of the space area allows a change from the prioritized display section of a particular display item to a larger original size, the size of the display item from the smaller size including the prioritized display section to a larger original size.

16. The information display apparatus according to claim 14, wherein said priority display condition includes priority orders predetermined to the plural display items, and wherein if there is a shortage of the space for adding the new display item, even after the resizing is carried out by the resizing unit, the display item arrangement unit deletes one or more of the display items already arranged according to the predetermined order of priority.

17. The information display apparatus according to claim 16, further comprising:
a history information obtainer for obtaining history information regarding use of respective applications associated with the display items; and
a priority order updater for updating the priority orders of the display items based on the history information obtained.

18. The information display apparatus according to claim 16, wherein said arrangement unit deletes, when deleting one of the display items to which the prioritized display section is set, part of the display item with at least the prioritized display section thereof left undeleted.

19. An information display method for displaying information on a display screen of a display device, comprising the steps of:
recognizing a change of at least one of a size and a position of a displayable area for displaying therein a display item on the display screen;
designating a priority display condition which is used when part of plural display items to be displayed in the displayable area is selectively displayed in the displayable area;
selecting part from the plural display items according to the priority display condition, when the change of at least one of the size and the position of the displayable area is recognized and when it is not possible to place the images in the displayable area; and
placing the selected part in the displayable area.
